(19) United States
(12) Patent Application Publication
(10) Pub. No.: US 2004/0073598 A1
(43) Pub. Date: Apr. 15, 2004

(54) System-to-system inter-operation interface

(75) Inventors: Christopher Dean, Ottawa (CA); Stephen Mason, Gloucester (CA); Cyril Soga, Orleans (CA); Julien Brainerd, Nepean (CA); Alain Lemoine, Ottawa (CA); Dmytro Toptygin, Ottawa (CA)

Correspondence Address: OBLON, SPIVAK, MCCLELLAND, MAIER & NEUSTADT, P.C., 1940 DUKE STREET, ALEXANDRIA, VA, 22314, US

(73) Assignee: EFTIA OSS SOLUTIONS INC., Ottawa (JP)

(21) Appl. No.: 10/654,947

(22) Filed: Sep. 5, 2003

Related U.S. Application Data
(60) Provisional application No. 60/408,290, filed on Sep. 6, 2002.

(51) Int. Cl. G06F 15/16

(52) U.S. Cl. 709/200

(57) ABSTRACT

The present invention provides an interface in a first computer application system that can be utilized by other computer application systems to invoke the execution of an action (e.g. a functional process) on the first system. The first system can support multiple different actions each with distinct functionality. A single entry point in an externally accessible interface is used regardless of which action is invoked. Each invocation of the entry point includes two parameters. The first to designate which of the actions is to be invoked. The second provides for the referencing of data elements that can supply input arguments used during execution of the action. The single entry point is not exposed to the semantic of the supplied arguments. Therefore the action execution interface does not need to change when the semantic specific to any of the actions is changed or when a new action is added.

### FIELD OF INVENTION

The present invention relates to the field of computer application system-to-system inter-operation. More specifically, to the area of interface architectures that support this inter-operation.

### BACKGROUND

The growing automation of business processes has lead to a proliferation of management systems in use in many enterprises. In order to achieve the levels of effectiveness desired of these systems there is an increasing need to provide for inter-operation of these systems. Traditionally, inter-operation of system has relied on the provisioning of an externally invocable interface by one system and the adaptation for use of this interface by other systems. Typically the interface has taken the form of multiple entry points each dedicated to the execution of a specific function within the system. Each external system needs to implement invocation points corresponding to each of the entry points representing a specific function within the system that the external system wishes to inter-operate with. Where the protocol and semantics for interaction are well-developed and relatively static, this approach has worked well. However, where the nature of inter-operation between the systems is dynamic, for example where one or more of the systems is evolving or frequently being adapted, the multiple entry-point approach requires frequent modification and revision. Also, where the breath of inter-operation between systems is significant, the multiple entry-point approach requires significant initial investment in developing the protocols and semantics of the inter-operation before the systems can be made to inter-act.

Given the growing complexity and the ongoing evolution of many management systems a solution is required that reduces the amount of modification and revision to interfaces and minimizes the investment in developing the protocols and semantics needs to enable effective inter-operability of systems.

### SUMMARY OF INVENTION

In accordance with one aspect of the present invention, an apparatus for processing a request for execution of one of a plurality of actions, each action having a specific semantic for input arguments to be provided to said action, said request for execution having a plurality of parameters, a first parameter of said plurality of parameters designating an action within said plurality of actions and a second parameter of said plurality of parameters for referencing a plurality of data elements arranged according to the specific semantic for input arguments to be provided to said action, said apparatus comprising: an interface for receiving said request for execution; and an agent for selecting said designated action, executing said selected action and providing as input arguments to said action said plurality of data elements.

In accordance with another aspect of the present invention, a method for processing a request for execution of one of a plurality of actions, each action having a specific semantic for input arguments to be provided, said request for execution having a plurality of parameters, a first parameter of said plurality of parameters designating an action within said plurality of actions and a second parameter of said plurality of parameters for referencing a plurality of data elements arranged according to the specific semantic for input arguments to be provided to said action, comprising steps for: receiving said request for execution; selecting said designated action from said plurality of actions; executing said selected action; and providing as said input arguments to said selected action said plurality of data elements.

In accordance with yet another aspect of the present invention, a computer program product for processing a request for execution of one of a plurality of actions, each action having a specific semantic for input arguments to be provided, said request for execution having a plurality of parameters, a first parameter of said plurality of parameters designating an action within said plurality of actions and a second parameter of said plurality of parameters for referencing a plurality of data elements arranged according to the specific semantic for input arguments to be provided to said action, the computer program product comprising computer executable program code devices for: receiving said request for execution; selecting said designated action from said plurality of actions; executing said selected action; and providing as said input arguments to said selected action said plurality of data elements.

Other aspects and features of the present invention will become apparent to those ordinarily skilled in the art upon review of the following description of specific embodiments of the invention in conjunction with the accompanying figures.

### BRIEF DESCRIPTION OF DRAWINGS

The present invention will be described in conjunction with the drawings in which:

FIG. 1 represents an exemplary environment in which an exemplary embodiment of the present invention can be used.

FIGS. 2 A&B illustrate a flowchart representing steps in a process for executing an atomic action according to an exemplary embodiment of the present invention.

FIG. 3 illustrates a flowchart representing steps in a process for executing a list action according to an exemplary embodiment of the present invention.

FIG. 4 represents an exemplary computing platform on which the present invention can be implemented.

### DETAILED DESCRIPTION

The present invention provides an action interface in a first computer application system (first system) which can be utilized by other computer application systems (other systems) to inter-operate with the first system. The inter-operation takes the form of any of the other systems invoking (i.e. requesting) the execution of an action (e.g. a functional process) on the first system. The first system can support multiple different actions each with distinct functionality. In an exemplary embodiment of the present invention the other systems utilize a single entry point in an externally accessible interface regardless of which action is invoked. Each invocation of the entry point includes a number of parameters. In the present embodiment two parameters will be used. The first parameter is used to designate which of the actions is to be invoked. The second parameter provides for the referencing of data elements that can supply input arguments used by the action during execution and that also can return the results generated during execution of the action. The single entry point is not exposed to the semantic of the supplied arguments or of the returned results. Each invocation via the single entry point can result in the execution of any of a plurality of actions each having a specific semantic for arguments supplied to and results returned from the action. The single entry point in the interface does not contain any artifacts of the semantic specific to each of the actions. Therefore the action execution interface does not need to change when the semantic specific to any of the actions is changed or when a new action is added.

In an exemplary embodiment of the present invention, the parameters are defined in a commonly used, open protocol such as Extensible Mark-up Language (XML). In an alternative embodiment any well known or private protocol that supports general data exchange can be used such as Standard Generalized Mark-up Language (SGML), Electronic Data Interchange (EDI) or other similar protocols.

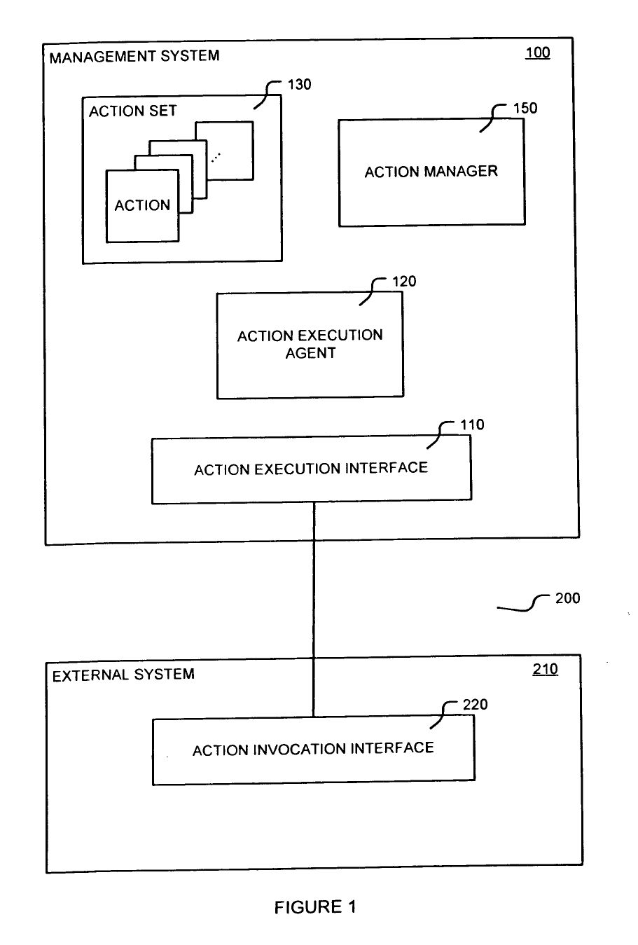

FIG. 1 and the associated description represent an exemplary environment 200 in which an exemplary embodiment of the present invention can be used. A management system 100 can inter-operate with other systems such as an external system 210. The management system 100 has an action execution interface 110 through which it inter-operates with the external system 210 via an action invocation interface 220. Inter-operation between the management system 100 and the external system 210 takes the form of the external system 210 invoking the execution of an action on the management system 100. Actions are executable processes on the management system 100 that render a well-defined function such as, for example, creating, modifying or deleting a resource, accessing and returning a specified element of information, receiving and storing a specified element of information and other similar functions. The management system provides for an action set 130 comprising a multitude of actions each rendering a potentially distinct function and each being distinguishable via a unique identifier (e.g. an action id)

The external system 210 provides two parameters when it invokes the execution of an action from the action set 130. A first parameter designates the action to be executed. A second parameter provides for the referencing of data elements by the designated action. The data elements can comprise both data items to be provided as input arguments to the execution of the action and data items that are returned as results output from the execution of the action. Referencing of the data elements is provided for by use of an indirect addressing mechanism such as, for example, memory pointer, stack pointer, link or other similar mechanism which is resolved when the data elements are referenced.

In an alternative embodiment three or more parameters could be provided. In the case of three parameters, for example, the first parameter would have the same function as in the two parameter embodiment while the second parameter would provide for the referencing of data elements that provide input to the execution of the action and the third parameter would provide for the referencing of data elements that return results output from the execution of the action.

In other embodiments, well known alternative structures such as, for example, a single parameter having the form of a list, tag/value pairs, comma separated values (CSV) in a published format and other similar structures are used to provide equivalent data exchange functionality as in the above described embodiments.

The management system 100 further comprises an action execution agent (AEA) 120 that contributes to the processing of the action execution invocations received at the action execution interface 110. The AEA 120 selects an action to execute from the action set 130 as designated by the first parameter. The AEA 120 also references a plurality of data elements from the second parameter to provide to the selected action.

Execution of the (selected) action is also provided for by the AEA 120. Before executing the action proper, the AEA 120 applies access control and validation constraints. The access control constraints ensure that, for example, the external system 210 invoking the action is authorized to do so or other similar security related checks. If the external system 210 is not authorized, execution of the action is terminated. An exception indication can optionally be returned to the external system 210 via the second parameter referenced data elements. The validation constraints can, for example, include: verifying the availability status of the action, verifying the version of the protocol applied to the first and second parameters, and other similar validation checks. If any of these validation constraints are not met, execution of the action is terminated. An exception indication can optionally be returned to the external system 210 via the second parameter referenced data elements.

If the access control and validation constraints are met, execution of the action proceeds. Execution of the action can differ as a function of the action type. Actions in the action set 130 can, for example, be of the types atomic action and action list. For simplicity herein after, ‘atomic action’ refers to an action of the type atomic action and ‘action list’ refers to an action of the type action list. An atomic action is one that does not directly invoke other actions during its execution. An action list is an ordered list of two or more actions to be executed in sequence. The action list can contain both atomic actions and other action lists.

Execution of an atomic action, after access control and validation constraints are met, comprises a pre-rule set phase, an action process phase and a post-rule set phase. For any given atomic action each of the pre-rule set, the action process and the post-rule set phases can result in a null operation, however a valid action always contains at least one non-null operation. In the pre-rule set phase, a set of business rules is executed to ensure that action pre-conditions are met. The set of business rules is specified as part of the definition of the action. During the action process phase computer program instructions that render the function associated with the atomic action are executed. The implementation of actions on the management system 100 can take many well known forms such as, for example, compiled program procedures, object methods, executable scripts and other similar computer executable implementations. In the post-rule set phase, a set of business rules is executed to ensure that action post-conditions are met. The set of business rules is specified as part of the definition of the action. In the event that any of the pre-rule set, the action process and the post-rule set phases fail, execution is terminated at the point of failure and an exception indication can optionally be returned to the external system 210 via the second parameter referenced data elements. In one embodiment of the present invention any failure (exception) in the execution of an action will result in any processing that has occurred in the execution of the action to be rolled-back.

Execution of an action list, after access control and validation constraints are met, comprises the sequential execution of the actions in the action list. If an executed action terminates successfully and returns result parameters, these parameters are made available to the next action in the list when it executes. If any of the actions in the action list fails during execution, execution is terminated at the point of failure, the previously executed actions in the action list are rolled-back and an exception indication can optionally be returned to the external system 210 via the second parameter referenced data elements.

A system user, a system administrator, a system operator and other similar parties can use an action manager (AM) 150 to create, modify or delete actions in the action set 130. The AM 150 provides for these parties to carry out these functions via a programmatic interface for machine-to-machine interaction, a browser-style interface for machine-to-human interaction via a data connection and a data terminal or other similar interfaces.

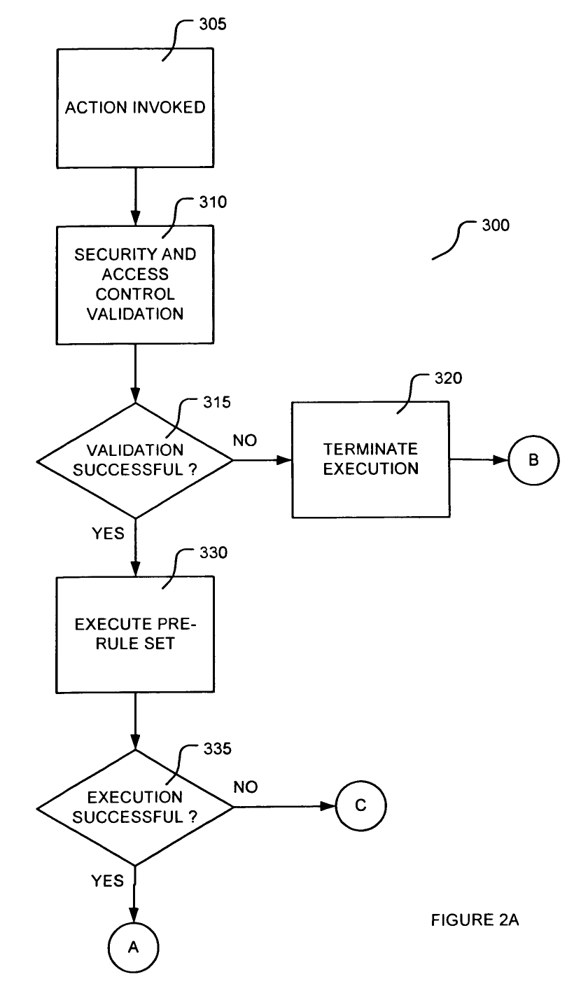

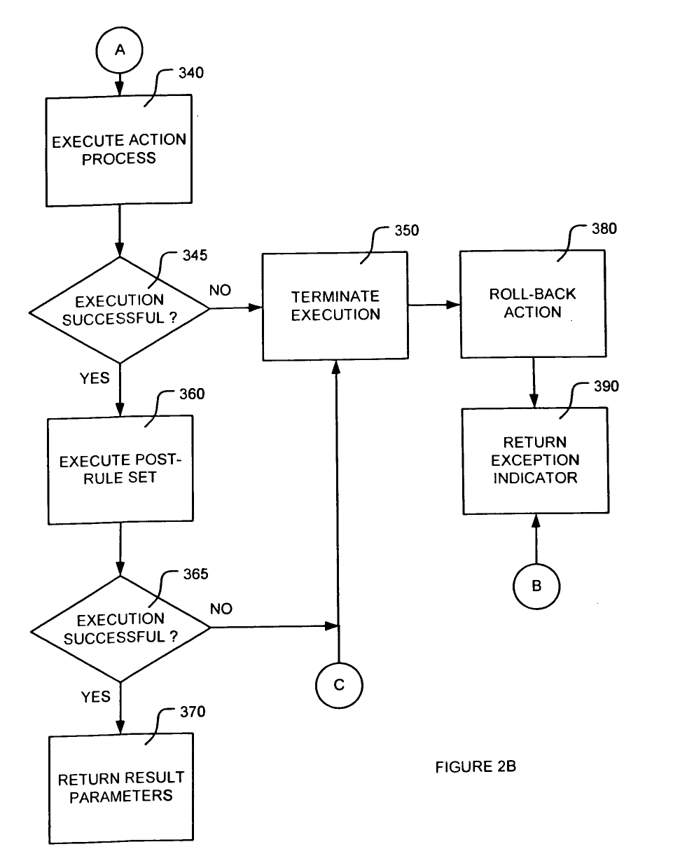

FIGS. 2 A & B illustrate a flowchart representing a process 300 for executing an atomic action according to an exemplary embodiment of the present invention. Execution begins when the action is invoked 305 as a result of the inter-operation of the action invocation interface 220 in the external system 210 and the action execution interface 110 in the management system 100. The action execution agent 120 selects an action to be executed, from the action set 130, based on a first parameter. Security and access control validation 310 is carried out to, for example, ensure integrity of the management system 100 and to enforce only authorized execution of the action. If validation is not successful 315 then the execution is terminated 320 and an exception indicator is returned 390 to the action invocation interface 220 via data elements referenced from a second parameter. If validation is successful 315 a pre-rule set is executed 330. If pre-rule set execution is not successful 335 then execution of the action is terminated 350, any changes made up to that point in the execution of the action are rolled-back 380 and an exception indicator is returned 390 to the action invocation interface 220 via data elements referenced from the second parameter. If pre-rule set execution was successful 335, a process that implements the action is executed 340 with data elements referenced from a second parameter being provided as input arguments. If execution of the action is unsuccessful 345 then execution of the action is terminated 350, any changes made up to that point in the execution of the action are rolled-back 380 and an exception indicator is returned 390 to the action invocation interface 220 via data elements referenced from the second parameter. If execution of the action is successful 345 a post-rule set is executed 360. If post-rule set execution is not successful 365 then execution of the action is terminated 350, any changes made up to that point in the execution of the action are rolled-back 380 and an exception indicator is returned 390 to the action invocation interface 220 via data elements referenced from the second action parameter. If post-rule set execution is successful 365 result parameters from the execution of the action are returned 370 to the action invocation interface 220 via data elements referenced from the second parameter.

A pre-rule set can, for example, provide for conditional execution based on the value of a parameter, send an alert indication, verify that all relationships involving a resource have been severed before allowing the deletion of the resource or other similar functions. A post-rule set can, for example, provide for conditional execution based on the value of a parameter, make an entry in a log file, verify that the resulting state of a resource is consistent with the action executed or other similar functions.

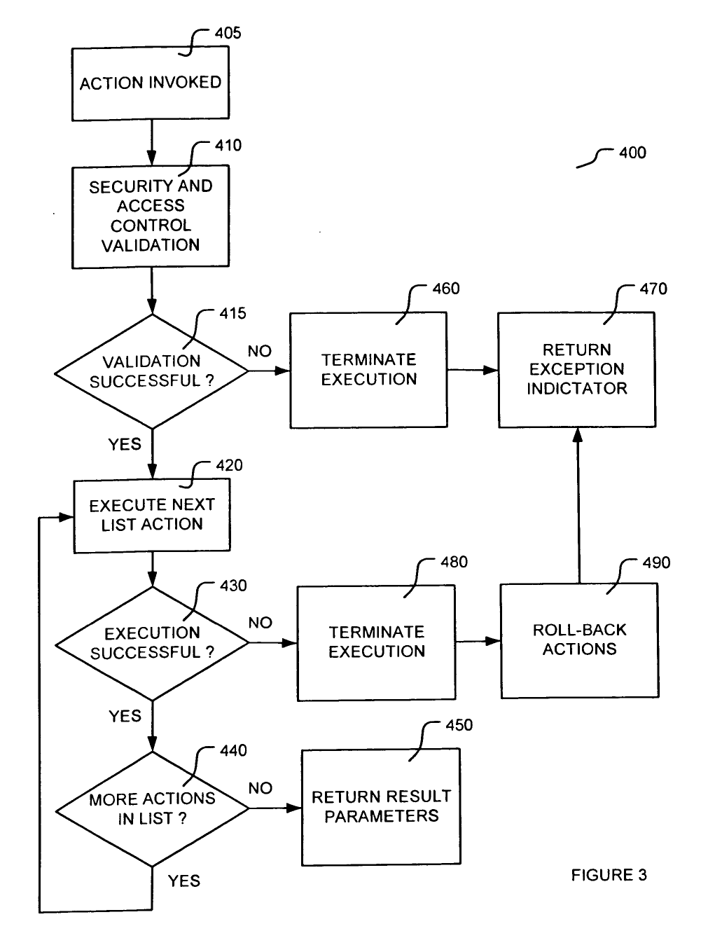

FIG. 3 illustrates a flowchart representing a process 400 for executing a list action according to an exemplary embodiment of the present invention. Execution begins when the action is invoked 405 as a result of the inter-operation of the action invocation interface 220 in the external system 210 and the action execution interface 110 in the management system 100. The action execution agent 120 selects an action to be executed, from the action set 130, based on a first parameter. Security and access control validation 410 is carried out to, for example, ensure integrity of the management system 100 and to enforce only authorized execution of the action. If validation is not successful 415 then the execution is terminated 460 and an exception indicator is returned 470 to the action invocation interface 220 via data elements referenced from a second parameter. If validation is successful 415 then a next (in this case a first) action in the action list is executed 420 with data elements referenced from a second parameter being provided as input arguments. Execution of the action 420 can follow, for example, the process represented in FIG. 2 in the case of an atomic action or the process represented in FIG. 3 in the case of a list action. If execution of the action is unsuccessful 430 then execution of the action is terminated 480, any previously executed actions in the action list are rolled-back 490 and an exception indicator is returned 470 to the action invocation interface 220 via data elements referenced from the second parameter. If execution of the action is successful 430 then the presence of more, as yet unexecuted, actions in the action list 440 is tested. If more (unexecuted) actions exist 440 then a next action in the action list is executed 420 and steps as described above are followed. If there are no more (unexecuted) actions in the action list 440 then result parameters from the execution of the action are returned 450 to the action invocation interface 220 via data elements reference from the second parameter.

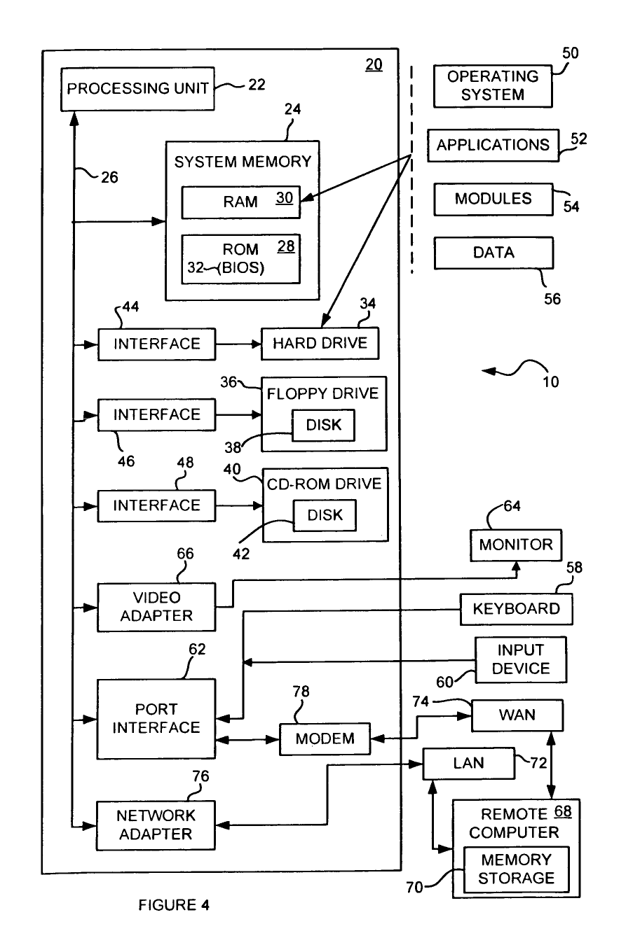

FIG. 4 and the associated description represent an example of a suitable computing environment in which the present invention may be implemented. While the invention is described in the context of implementation in the form of computer-executable instructions of a program that runs on a conventional computing platform, the invention can also be implemented in combination with other program modules.

Generally, program modules include routines, programs, components, data structures and the like that perform particular tasks or implement particular abstract data types. Further, the present invention can also be implemented using other computer system configurations, including multiprocessor systems, personal computers, mainframe computers, hand-held devices, microprocessor-based or programmable consumer electronics and the like. The invention can also be practiced in distributed computing environments wherein tasks are performed by remote processing devices that are linked through a communications network. In a distributed computing environment, program modules may be located in both local and remote memory storage devices.

With reference to FIG. 4, an exemplary system 10 includes a conventional computer 20, including a processing unit 22, a system memory 24, and a system bus 26 that couples various system components including the system memory 24 to the processing unit 22. The system bus 26 includes several types of bus structures including a memory bus or memory controller, a peripheral bus, and a local bus using any of a variety of conventional bus architectures (e.g., PCI, VESA, ISA, EISA etc.)

The system memory 24 includes read only memory (ROM) 28 and random access memory (RAM) 30. A basic input/output system (BIOS) 32, containing the basic routines that help to transfer information between elements within the computer 20, such as during start-up, is stored in the ROM 28. The computer 20 also includes a hard disk drive 34, magnetic disk drive 36 (to read from and write to a removable disk 38), and an optical disk drive 40 (for reading a CD-ROM disk 42 or to read from or write to other optical media). The drives 34, 36 and 40 are connected to the system bus 26 by interfaces 44, 46 and 48, respectively.

The drives 34, 36 and 40 and their associated computer-readable media (38, 42) provide nonvolatile storage of data, data structures, and computer-executable instructions for the computer 20. The storage media of FIG. 4 are merely examples and it is known by those skilled in the art to include other types of media that are readable by a computer (e.g., magnetic cassettes, flash memory cards, digital video disks, etc.).

A number of program modules may be stored in the drives 34, 36 and 40 and the RAM 30, including an operating system 50, one or more application programs 52, other program modules 54 and program data 56. A user may enter commands and information into the computer 20 through a keyboard 58 and an input device 60 (e.g., mouse, microphone, joystick, game pad, satellite dish, scanner etc.) These devices (58 and 60) are connected to the processing unit 22 through a port interface 62 (e.g., serial port, parallel port, game port, universal serial bus (USB) etc.) that is coupled to the bus 26. A monitor 64 or other type of display device is also connected to the bus 26 through an interface 66 (e.g., video adapter).

The computer 20 may operate in a networked environment using logical connections to one or more remote computers, such as remote computer 68. The remote computer 68 may be a server, a router, a peer device or other common network node, and typically includes many or all of the elements described in relation to the computer 20, although for simplicity only a memory storage device 70 is shown. The logical connections shown in FIG. 4 include a local area network (LAN) 72 and a wide area network (WAN) 74. Such networking environments are commonly used in offices, enterprise-wide computer networks, intranets and the Internet.

When used in a LAN networking environment, the computer 20 is connected to the LAN 72 through a network interface or adapter 76. When used in the WAN networking environment, the computer 20 typically includes a modem 78 or other means for establishing communications over the WAN 74, such as the Internet. The modem 54, which may be internal or external, is connected to the bus 26 through the port interface 62. In a networked environment, program modules depicted relative to the computer 20, or portions thereof, may be stored in the remote memory storage device 70.

It will be apparent to one skilled in the art that numerous modifications and departures from the specific embodiments described herein may be made without departing from the spirit and scope of the present invention.

1. An apparatus for processing a request for execution of one of a plurality of actions, each action having a specific semantic for input arguments to be provided to said action, said request for execution having a plurality of parameters, a first parameter of said plurality of parameters designating an action within said plurality of actions and a second parameter of said plurality of parameters for referencing a plurality of data elements arranged according to the specific semantic for input arguments to be provided to said action, said apparatus comprising:
an interface for receiving said request for execution; and
an agent for selecting said designated action, executing said selected action and providing as input arguments to said action said plurality of data elements.

2. The apparatus of claim 1, a third parameter of said plurality of parameters for referencing additional data elements for receiving a return value generated by said action, said agent further for receiving into said additional data elements referenced from said third parameter a return value generated by said action.

3. The apparatus of claim 2 wherein said second parameter and said third parameter are the same parameter.

4. The apparatus of claim 1 further having access control and validation constraints to be validated before execution of said selected action, and said agent further for validating said request for execution using said access control and validation constraints before executing said selected action.

5. The apparatus of claim 1 further comprising a manager for creating, modifying and deleting an action in said plurality of actions.

6. The apparatus of any of claims 1 to 5 wherein each of said plurality of actions is a functional process.

7. A method for processing a request for execution of one of a plurality of actions, each action having a specific semantic for input arguments to be provided, said request for execution having a plurality of parameters, a first parameter of said plurality of parameters designating an action within said plurality of actions and a second parameter of said plurality of parameters for referencing a plurality of data elements arranged according to the specific semantic for input arguments to be provided to said action, comprising steps for:
receiving said request for execution;
selecting said designated action from said plurality of actions;
executing said selected action; and
providing as said input arguments to said selected action said plurality of data elements.

8. The method of claim 7, a third parameter of said plurality of parameters for referencing additional data elements for receiving a return value generated by said action, further comprising a step for receiving into said additional data elements referenced from said third parameter a return value generated by said action.

9. The method of claim 8 wherein said second parameter and said third parameter are the same parameter.

10. The method of claim 7 further having access control and validation constraints to be validated before execution of said selected action, and further comprising a step for validating said request for execution using said access control and validation constraints before executing said selected action.

11. The method of any of claims 7 to 10 wherein each of said plurality of actions is a functional process.

12. A computer program product for processing a request for execution of one of a plurality of actions, each action having a specific semantic for input arguments to be provided, said request for execution having a plurality of parameters, a first parameter of said plurality of parameters designating an action within said plurality of actions and a second parameter of said plurality of parameters for referencing a plurality of data elements arranged according to the specific semantic for input arguments to be provided to said action, the computer program product comprising computer executable program code devices for:
receiving said request for execution;
selecting said designated action from said plurality of actions;
executing said selected action; and
providing as said input arguments to said selected action said plurality of data elements.

13. The computer program product of claim 12, a third parameter of said plurality of parameters for referencing additional data elements for receiving a return value generated by said action, the computer program product further comprising computer executable program code devices for receiving into said additional data elements referenced from said third parameter a return value generated by said action.

14. The computer program product of claim 13, wherein said second parameter and said third parameter are the same parameter.

15. The computer program product of claim 12, further having access control and validation constraints to be validated before execution of said selected action, and the computer program product further comprising computer executable program code devices for validating said request for execution using said access control and validation constraints before executing said action.

16. The computer program product of any of claims 12 to 15, wherein each of said plurality of actions is a functional process.
